(19) United States
(12) Patent Application Publication
(10) Pub. No.: US 2008/0174719 A1
(43) Pub. Date: Jul. 24, 2008

(54) Backlight Unit and Lcd Having the Same

(76) Inventor: Myong Rock Oh, Suwon-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/910,297

(22) PCT Filed: Mar. 15, 2007
(86) PCT No.: PCT/KR2007/001290

§ 371 Date: Oct. 1, 2007

(30) Foreign Application Priority Data
Mar. 20, 2006 (KR) 10-2006-0025453

(51) Int. Cl. G02F 1/1335; F21S 13/14

(52) U.S. Cl. 349/65; 362/252

(57) ABSTRACT

Provided is a backlight unit and an LCD device having the same. The backlight unit includes a light guide plate, a plurality of light-emitting units, and a printed circuit board. The plurality of light-emitting units provide light onto the light guide plate. The plurality of light-emitting units are formed in a plurality of lines on printed circuit board.

### TECHNICAL FIELD

The present invention relates to a backlight unit and a liquid crystal display (LCD) device having the same.

### BACKGROUND ART

A cathode ray tube (CRT) has been widely used as one of display devices for displaying image data on a screen. However, the CRT has been inconvenient for use because it has a large volume and a heavy weight for its display area.

A thin flat display device, which has a slim profile and a large display area and thus can be used conveniently anywhere, has been developed and is gradually replacing the CRT.

A liquid crystal display device (LCD) is driven using characteristics of liquid crystals, optical anisotropy and polarization. Since liquid crystal molecules are long and thin, the alignment of liquid crystal molecules has directivity. The alignment direction of the molecules may be controlled by artificially applying electric field to liquid crystals. Therefore, light can be transmitted or blocked according to the direction alignment of the liquid crystal molecules through the optical anisotropy of liquid crystals to display a color and an image.

Since the above-described LCD device cannot emit light in itself, it displays an image using light provided from the outside or a backlight unit.

FIG. 1 is a schematic view of a related art backlight unit.

Referring to FIG. 1, the related art backlight unit includes a light guide plate 10, a printed circuit board (PCB) 20, and a light-emitting unit 30. The PCB 20 may be a flexible PCB (FPCB). Also, the light-emitting unit 30 may be a light-emitting device such as a light-emitting diode (LED).

The light-emitting unit 30 is horizontally aligned on the same line of a light-incident part of the light guide plate 10 to provide light onto the light guide plate 10. The light-emitting unit 30 is horizontally arranged on the PCB 20 and can be mounted using surface mount technology (SMT). In the case where the PCB 20 is realized using an FPCB, the FPCB may be attached on the light-incident part of the light guide plate 10 using an adhesive member such as a double-sided tape.

Brightness of light emitted from the light-emitting unit 30 changes depending on an angle at which the light propagates. An angle at which brightness of light reduces to 50% of the brightness at the center of the light-emitting unit 30 is called a half luminance angle. The half luminance angle is generally about ±60° from a central line of the light-emitting unit 30. θ in FIG. 1 illustrates light propagates from the light-emitting unit 30 according to the half luminance angle. As described above, different amounts of light are provided via the light guide plate 10 depending on a region of the light guide plate 10. A dark portion 13 can be formed at a region to which light is incident from the light-emitting unit 30.

Meanwhile, the above-described backlight unit can be applied to an image display device such as an LCD device. Reference numeral 11 in FIG. 1 denotes an image display region of an image display device. As described above, in the case where the dark portion 13 exists inside the image display region 11, there is a problem that brightness of supplied light is not uniform depending on a region where an image is displayed, resulting in reduction of image quality of an image displayed on an image display device.

Meanwhile, the number of light-emitting units 30 provided to a backlight unit can be increased in order to increase brightness of an image display device such as an LCD device. However, since the light-emitting units 30 are aligned in a line at a light-incident part of the light guide plate 10, the number of light-emitting units 30 that can be formed is limited by limitation of the length of the light-incident part of the light guide plate 10.

Accordingly, a study is under progress to supply uniform light of high brightness over an entire region of a backlight unit.

### DISCLOSURE OF INVENTION

### Technical Problem

An embodiment of the present invention provides a backlight unit and an LCD device having the same, capable of supplying uniform light of high brightness.

An embodiment of the present invention provides a mobile communication terminal having a backlight unit for supplying uniform light of high brightness to display an image of high quality.

### Technical Solution

An embodiment of the present invention provides a backlight unit comprising: a light guide plate; a plurality of light-emitting units for providing light onto the light guide plate; and a printed circuit board on which the plurality of light-emitting units are formed in a plurality of lines.

An embodiment of the present invention provides a liquid crystal display device comprising: a backlight unit including a light guide plate, a plurality of light-emitting units for providing light onto the light guide plate, and a printed circuit board on which the plurality of light-emitting units are formed in a plurality of lines; and a liquid crystal panel for receiving light from the backlight unit.

An embodiment of the present invention provides a mobile communication terminal comprising: a backlight unit including a light guide plate, a plurality of light-emitting units for providing light onto the light guide plate, and a printed circuit board on which the plurality of light-emitting units are formed in a plurality of lines; a liquid crystal panel for receiving light from the backlight unit; a communicating element for communicating with an outside; and a control unit for controlling the backlight unit, the liquid crystal panel, and the communicating element.

### Advantageous Effects

According to the embodiments of the present invention, it is possible to provide a backlight unit and an LCD device having the same, capable of supplying uniform light of high brightness.

Also, according to the embodiments of the present invention, it is possible to provide a mobile communication terminal having a backlight unit for supplying uniform light of high brightness to display an image of high quality.

### BRIEF DESCRIPTION OF THE DRAWINGS

FIG. 1 is a schematic view of a related art backlight unit;

FIG. 2 is a view illustrating a backlight unit according to an embodiment of the present invention; and

FIG. 3 is a view illustrating a backlight unit according to another embodiment of the present invention.

### MODE FOR THE INVENTION

Reference will now be made in detail to the preferred embodiments of the present invention, examples of which are illustrated in the accompanying drawings.

FIG. 2 is a view illustrating a backlight unit according to an embodiment of the present invention.

Referring to FIG. 2, the backlight unit includes a light guide plate 110, a printed circuit board (PCB) 120, and a light-emitting unit 130. The PCB 120 may be a flexible PCB (FPCB). Also, the light-emitting unit 130 may be a light-emitting device such as a light-emitting diode (LED).

The light-emitting unit 130 can be mounted on the PCB 120 using surface mount technology (SMT). In the case where the PCB 120 is realized using an FPCB, the FPCB may be attached on the light-incident part of the light guide plate 110 using an adhesive member such as a double-sided tape.

The light-emitting unit 130 can be mounted in a plurality of lines on the PCB 120. FIG. 2 illustrates an example where the light-emitting unit 130 are aligned and mounted in two lines. Also, the light-emitting unit 130 may be arranged in zigzags, and an overlapping region can be controlled by differing alignment angles of the light-emitting unit 130 such that direction of emitted light is not the same.

Referring to FIG. 2, in the backlight unit according to an embodiment of the present invention, light-emitting units 130 are aligned in a plurality of lines when formed to correspond to light-incident parts of the light guide plate 110. That is, all of the light-emitting units 130 are not located at the same distance from the light-incident parts of the light guide plate 110. Some of the light-emitting units 130 are formed to be located at a close distance from the light-incident parts of the light guide plate 110, and others of the light-emitting units 130 are formed to be located at a relatively long distance from the light-incident parts of the light guide plate 110.

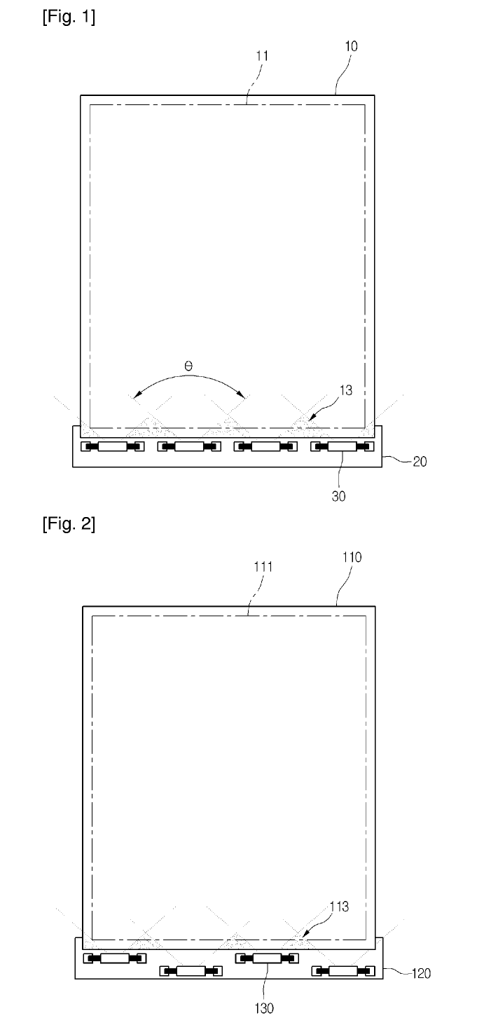

Brightness of light emitted from the light-emitting unit 130 changes depending on an angle at which the light propagates. An angle at which brightness of light reduces to 50% of the brightness at the center of the light-emitting unit 130 is called a half luminance angle. The half luminance angle is generally about ±60° from a central line of the light-emitting unit 130. FIG. 2 illustrates light propagates from the light-emitting unit 130 according to the half luminance angle. As described above, different amounts of light are provided via the light guide plate 110 depending on a region of the light guide plate 110. A dark portion 113 formed at a region to which light is incident from the light-emitting unit 130 reduces much compared to the related art backlight unit illustrated in FIG. 1.

The above-described backlight unit can be applied to an image display device such as an LCD device. Reference numeral 111 in FIG. 2 denotes an image display region of an image display device. As described above, in the case where the dark portion 113 exists inside the image display region 111, there is a problem that brightness of supplied light is not uniform depending on a region where an image is displayed, resulting in reduction of image quality of an image displayed on an image display device. According to the backlight unit of the embodiment of the present invention, the dark portion 113 can be reduced, and therefore, image quality reduction can be prevented in an image display device to which the backlight unit according to an embodiment of the present invention is applied.

As described above, in the backlight unit according to an embodiment of the present invention, a plurality of light-emitting units 130 are aligned and mounted in a plurality of lines, not in a line. Accordingly, the dark portion 113 can be moved to a portion outside the image display region 111, and the size of the dark portion 113 can be reduced.

Also, since the light-emitting units 130 are formed in the plurality of lines, the length limitation of the light-incident parts of the light guide plate 110 can be overcome and more light-emitting units can be mounted. Accordingly, brightness of light provided from the backlight unit can be improved even more.

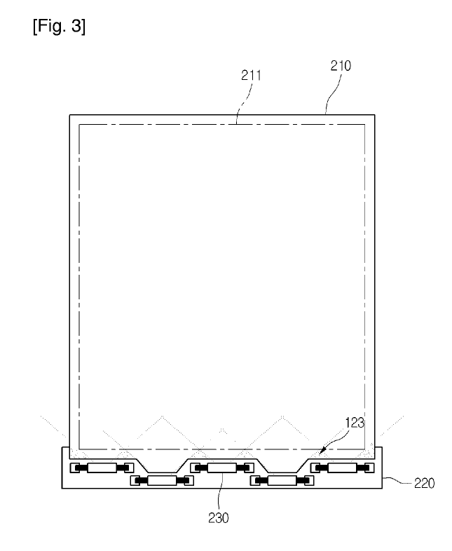

Meanwhile, in a backlight unit according to another embodiment of the present invention, a plurality of light-emitting units are formed in a plurality of lines such that the light-emitting units formed in different lines can overlap each other as illustrated in FIG. 3. FIG. 3 is a view illustrating the backlight unit according to another embodiment of the present invention.

Referring to FIG. 3, the backlight unit includes a light guide plate 210, a printed circuit board (PCB) 220, and a light-emitting unit 230. The PCB 220 may be a flexible PCB (FPCB). Also, the light-emitting unit 230 may be a light-emitting device such as a light-emitting diode (LED).

The light-emitting unit 230 can be mounted on the PCB 220 using surface mount technology (SMT). In the case where the PCB 220 is realized using an FPCB, the FPCB may be attached on the light-incident part of the light guide plate 210 using an adhesive member such as a double-sided tape.

Referring to FIG. 3, in the backlight unit according to another embodiment of the present invention, the light-emitting units 230 located in different lines are formed to overlap each other with respect to a direction of the light-incident parts of the light guide plate 210, so that a dark portion 123 can be prevented from being generated inside an image display region 211. Therefore, an image display device to which a backlight unit according to another embodiment of the present invention can supply uniform light over an entire range of an image display region, and provide a high quality image.

Also, referring to FIG. 3, in the backlight unit according to another embodiment of the present invention, the shape of the light guide plate 210 is modified. The light guide plate 110 illustrated in FIG. 2 has the line-shaped light-incident part of the light guide plate 210, but light-incident parts of the light guide plate 210 illustrated in FIG. 3 are not formed in a straight line shape. That is, the light-incident parts of the light guide plate 210 have a irregular shape such as a height difference. This irregular shape allows all of the light-incident parts of the light guide plate 210 to be closely attached to the light-emitting units 230. Therefore, light emitted from the light-emitting units 230 can be more efficiently incident on the light guide plate 210, and brightness of light provided via the light guide plate 210 can be improved on the whole.

The above-described backlight unit can be applied to an image display device such as a LCD device, and supplies uniform light of high brightness to a LCD panel to display a high quality image.

Meanwhile, the above-described backlight unit or LCD device can be applied to a mobile communication terminal and may be used in realizing a thin mobile communication terminal. A mobile communication terminal according to the embodiment includes a communication element for communicating with the outside, and a control unit for controlling the communication element and the backlight unit or the LCD device.

### INDUSTRIAL APPLICABILITY

As described above, a backlight unit and an LCD device having the same according to the embodiments of the present invention have an advantage of supplying uniform light of high brightness.

Also, a mobile communication terminal according to the embodiments of the present invention has a backlight unit for supplying uniform light of high brightness to display an image of high quality.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A backlight unit comprising:
a light guide plate;
a plurality of light-emitting units for providing light onto the light guide plate; and
a printed circuit board on which light emitting units of the plurality of light-emitting units are formed in a plurality of lines.

2. The backlight unit according to claim 1, wherein each light-emitting unit of the plurality of light-emitting units comprises a light-emitting device.

3. The backlight unit according to claim 1, wherein the plurality of light-emitting units is arranged in a zigzag pattern.

4. The backlight unit according to claim 1, wherein the light-emitting units of the plurality of light-emitting units are arranged such that directions of emitted light are not the same.

5. The backlight unit according to claim 1, wherein each light-emitting unit of the plurality of light-emitting units is formed at a different distance from light-incident parts of the light guide plate than other light-emitting units of the plurality oil light-emitting units.

6. The backlight unit according to claim 1, wherein irregular shapes are formed at light-incident parts of the light guide plate such that the light-incident parts of the light guide plate are closely attached on light-emitting surfaces of the light-emitting units of the plurality of light-emitting units to correspond to positions where the light-emitting units of the plurality of light-emitting units are formed.

7. The backlight unit according to claim 1, wherein the light-emitting units of the plurality of light-emitting units formed in different lines of the plurality of lines are formed to overlap each other with respect to a direction of light-incident parts of the light guide plate.

8. A liquid crystal display device comprising:
a backlight unit including a light guide plate, a plurality of light-emitting units for providing light onto the light guide plate, and a printed circuit board on which light-emitting units of the plurality of light-emitting units are formed in a plurality of lines; and
a liquid crystal panel for receiving light from the backlight unit.

9. The liquid crystal display device according to claim 8, wherein each light-emitting unit of the plurality of light emitting units comprises a light-emitting device.

10. The liquid crystal display device according to claim 8, wherein the plurality of light-emitting units is arranged in a zigzag pattern.

11. The liquid crystal display device according to claim 8, wherein the light-emitting units of the plurality of light-emitting units are arranged such that directions of emitted light are not the same.

12. The liquid crystal display device according to claim 8, wherein each light-emitting unit of the plurality of light-emitting units is formed at a different distance from light-incident parts of the light guide plate than other light-emitting units of the plurality of light-emitting units.

13. The liquid crystal display device according to claim 8, wherein irregular shapes are formed at light-incident parts of the light guide plate such that the light-incident parts of the light guide plate are closely attached on light-emitting surfaces of the light-emitting emitting units of the plurality of light-emitting units to correspond to positions where the light-emitting units of the plurality of light-emitting units are formed.

14. The liquid crystal display device according to claim 8, wherein the light-emitting units of the plurality of light-emitting units formed in different lines of the plurality of lines are formed to overlap each other with respect to a direction of light-incident parts of the light guide plate.

15. A mobile communication terminal comprising:
a backlight unit including a light guide plate, a plurality of light-emitting units for providing light onto the light guide plate, and a printed circuit board on which light-emitting units of the plurality of light-emitting units are formed in a plurality of lines;
a liquid crystal panel for receiving light from the backlight unit;
a communicating element for communicating with an outside; and
a control unit for controlling the backlight unit, the liquid crystal panel, and the communicating element.

16. The mobile communication terminal according to claim 15, wherein each light-emitting unit of the plurality of light-emitting units comprises a light-emitting device.

17. The mobile communication terminal according to claim 15, wherein the plurality of light-emitting units is arranged in a zigzag pattern.

18. The mobile communication terminal according to claim 15, wherein each light-emitting unit of the plurality of light-emitting units is formed at a different distance from light-incident parts of the light guide plate then other light-emitting units of the plurality of light-emitting units.

19. The mobile communication terminal according to claim 15, wherein irregular shapes are formed at light-incident parts of the light guide plate such that the light-incident parts of the light guide plate are closely attached on light-emitting surfaces of the light-emitting units of the plurality of light-emitting units to correspond to positions where the light-emitting units of the plurality of light-emitting units are formed.

20. The mobile communication terminal according to claim 15, wherein the light-emitting units formed in different lines of the plurality of lines are formed to overlap each respect to a direction of light-incident parts of the light guide plate.
